(19) United States
(12) Patent Application Publication
(10) Pub. No.: US 2009/0230150 A1
(43) Pub. Date: Sep. 17, 2009

(54) Refrigerated Core Comprising Carbonating System for Drinks Dispener

(76) Inventors: Eric Dietschi, Chardonne (CH); Eric Fournier, Saint Sylvestre Pragoulin (FR); Alexandre Pereira, Valence (FR)

Correspondence Address: STEVEN T. ZUCHLAG ESQ.;HOFFMAN & BARON LLP, 6900 JERICHO TRUNPIKE, SYSOSSET, NY, 11791, US

(21) Appl. No.: 11/885,420

(22) PCT Filed: Mar. 1, 2006
(86) PCT No.: PCT/IB06/00420

§ 371 Date: Jul. 23, 2008

(30) Foreign Application Priority Data
Mar. 1, 2005 (EP) 05290467

(51) Int. Cl. B67D 5/08; B67D 5/62; B67D 5/60

(52) U.S. Cl. 222/146.6; 222/64; 422/291

(57) ABSTRACT

The present invention relates to Integrated core (18) adapted for use in a beverage dispenser system, comprising a multi-chamber cooling system comprising an outer upper chamber (21) and a inner lower chamber (22), the inner lower chamber (22) being located partially within the upper outer chamber (21) and interconnected in such a way to permit a fluid to flow from the upper chamber (21) to the lower chamber (22) and vice-versa; beverage transport means (26, 27, 28, 29, 30) distributed throughout the upper chamber (21) capable of transporting beverage to be cooled through said upper chamber (21); cooling means (34) distributed throughout substantially a lower zone (32) of the lower chamber (22); cooling transfer fluid distributed throughout both chambers (21, 22) and capable of flowing from one chamber to the other; and a beverage carbonator (35), located substantially in an upper zone (31) of the inner lower chamber (22).

The present invention relates to beverage dispensers, in particular water dispensers, such as the type in which water stored in a water bottle or from a piped source is fed into the dispenser, and are well known as such. In the case of a bottled water dispenser, the bottled water is place either above the dispenser, usually in an inverted position such that the neck and opening of the bottle meet with a feeder tube in the dispenser, and the water in the bottle falls into the dispenser by gravity, or via an air pump that injects air via an air filter unit into the bottle, or else the bottle is placed underneath the dispenser and pumped into the dispenser circuit. In the case of piped water, water is generally taken from a domestic supply of water to a building and the pressure from such domestic supply is used to introduce the water into the dispenser system.

Most of the beverage dispenser systems described generally above have means for varying the temperature of the water being dispensed. Usually, the water is chilled using cooling means or a heat exchanger system, but the water can also occasionally be heated, if that is so desired. In some cases, the water is carbonated via injection of carbon dioxide gas under pressure into the water line of the dispenser. This enables a carbonated water stream to be dispensed.

One of the problems with typical water dispensers that integrate both cooling and carbonating systems is that they tend to be bulky. In addition, they tend to be complex to maintain, because the various separate components do not fit easily together. Generally, most carbonating systems are separate from the main intake of water, such that the gas injector nozzles and injection chamber are removed from the direct intake. This does not facilitate maintenance of the dispenser, since each functional section has to be attended to separately, which is very costly and time consuming.

The inventors of the present invention have surprisingly managed to create a fully functional integrated core, that is usable in a beverage dispenser, such as the water dispenser systems of the type described above, and which integrates a compact cooling system, as well as a carbonating system, into a single unit. The core of the invention thereby enables dispensing of carbonated water along with room temperature water, chilled water and optionally heated water as desired.

Accordingly, one object of the present invention is an integrated core adapted for use in a beverage dispenser system, comprising:

a multi-chamber cooling system comprising an outer upper chamber and a inner lower chamber, the inner lower chamber being located partially within the upper outer chamber and interconnected in such a way to permit a fluid to flow from the upper chamber to the lower chamber and vice-versa;

beverage transport means distributed throughout the upper chamber capable of transporting beverage to be cooled through said upper chamber;

cooling means distributed throughout substantially a lower zone of the lower chamber;

cooling transfer fluid distributed throughout both chambers and capable of flowing from one chamber to the other;

a beverage carbonator, located substantially in an upper zone of the inner lower chamber.

According to a preferred embodiment, the inner lower chamber is in substantial axial alignment with the upper outer chamber. In another preferred embodiment, the inner lower chamber is displaced axially with respect to the upper outer chamber.

In still yet another preferred embodiment, the cooling transfer fluid is water, a saline solution containing mineral or polymer anions or cations, or a eutectic fluid, and having a predetermined freezing point, for example −10° C., −15° C., or −20° C.

In the most preferred embodiment the carbonator comprises:

a carbonated beverage storage chamber;

a beverage inlet enabling beverage to enter the carbonated beverage storage chamber and be stored there temporarily;

a carbonated beverage outlet enabling carbonated beverage to be withdrawn from the carbonated beverage storage chamber;

a carbon dioxide inlet enabling carbon dioxide gas to be injected into the storage chamber.

Preferably, the incoming beverage stream is cooled prior to introduction into the storage chamber, and is at a pressure of between about 0.5 to 9 bar, and most preferably 5 bar+/−1 bar, the beverage pressure being superior to the pressure of the carbon dioxide gas entering the storage chamber. Even more preferably, the incoming beverage stream entering the storage chamber is pre-cooled, preferably at a temperature comprised between about 2° C. to about 3° C. In such a preferred embodiment, the incoming beverage stream is withdrawn from the flow of beverage that has been cooled after transport via the beverage transport means through the upper chamber. Alternatively, the beverage can be chilled after leaving the storage chamber, or further chilled after leaving said storage chamber. Preferably, the outflowing beverage stream leaving the storage chamber is cooled after having left beverage outlet.

In another preferred embodiment, the carbon dioxide gas is introduced into the storage chamber at a pressure comprised between about 4.5 bar and 7.5 bar, preferably at about 4.5 bar+/−1 bar. Even more preferably, the carbon dioxide gas is pre-cooled before introduction into the storage chamber to a temperature comprised between about 2° C. to about 3° C.

In still yet another particularly preferred embodiment, the carbon dioxide gas inlet also comprises a conduit that extends via a stepped reduction in diameter to a second narrower conduit and an injection orifice into the carbonated beverage storage chamber. Preferably, the carbon dioxide gas inlet also comprises a primer conduit that connects the gas inlet to a non-return valve.

It is most preferred that the carbonator have a volume comprised between about 400 ml to about 1.5 litres, and even more preferably from about 400 ml to about 500 ml. The carbonator may also preferably comprise a baffle adapted in shape and form to prevent pockets of CO2 gas from forming in a beverage outlet column, a vent to relieve any eventual excess gas pressure in the beverage storage chamber, and carbonated water level detection means. Where the carbonator comprises such detection level means, the latter can advantageously comprise two electrodes connected to an alternating current. These two electrodes are preferably housed in a housing that projects down into the carbonated beverage storage chamber. In this way, the electrodes are protected from eddies, or splashing, caused by the beverage stream being injected into the storage chamber, since the housing provides a relatively confined volume into which the electrodes dip that is substantially undisturbed by any such movement.

In a particularly preferred embodiment, the beverage carbonator is located above the cooling means in the lower chamber, and is most preferably totally immersed in cooling transfer fluid.

Another object of the present invention is a beverage dispenser comprising a beverage source, one or more taps for dispensing said beverage, and a flow path means providing a stream of beverage from the source of beverage to the taps, wherein the dispenser also comprises an integrated core according to the first object of the invention.

Preferably, however, the beverage dispenser also comprises a sanitisation system connected to the integrated core, comprising means for generating heat of a temperature sufficient to substantially destroy any bacteria within the integrated core, carbonator and flow path means. More preferably, the means for generating heat comprise an electric current supply connected to one or more of the flow path means, the beverage transport means and the beverage inlet and carbonated beverage outlet, and one or more of the former are made of an electrically conducting material. Even more preferably, the beverage dispenser comprises means for generating heat which comprise a supply of sanitising vapour that is transported either via its own vapour pressure or via a purge system through one or more of the flow path means, integrated core, and carbonator.

In the most preferred embodiments of the present invention, the beverage is drinking water, and even more preferably, such drinking water can be supplied by a water bottle or carboy or a domestic water supply.

### BRIEF DESCRIPTION OF THE FIGURES

FIG. 1 is a schematic sectional representation of the functional principal of a beverage dispenser system, in particular a water dispenser system using a water bottle, or carboy as the source of beverage.

FIG. 2 is a schematic sectional representation of the integrated core comprising a carbonator according to the present invention.

FIG. 3 is a sectional view of the carbonator forming part of the present invention, the section being made through a carbon dioxide gas inlet.

FIG. 4 is another sectional view of carbonator according to the present invention, the section being made through a beverage inlet into the carbonator.

FIG. 5 is yet another sectional view of the carbonator according to the invention, the section being made through a carbonate beverage outlet leading out from the carbonator.

FIG. 6 is yet another sectional view of the carbonator according to the present invention, the section being made through beverage level detection means within the carbonator.

The invention will be further described by the following detailed example of a preferred embodiment, in association with the figures, and is intended to serve as an illustration of the general inventive concept underlying said invention.

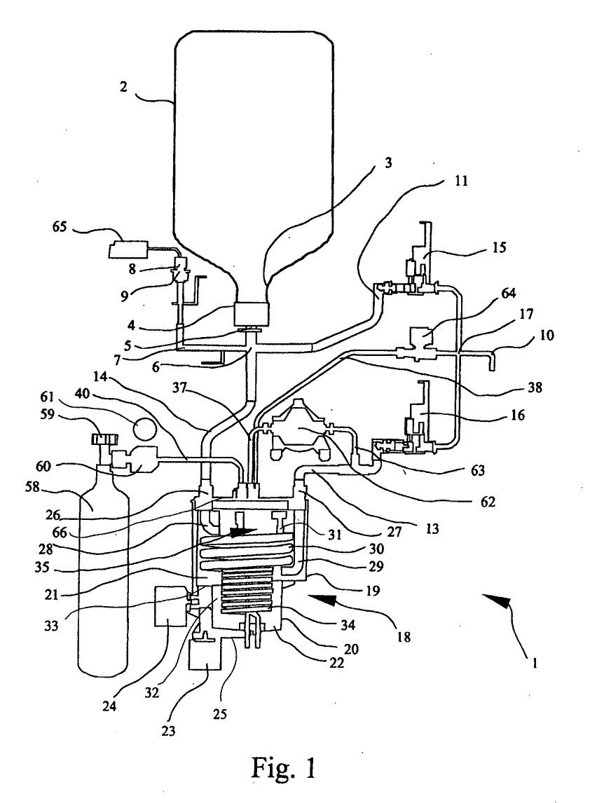

As mentioned above, FIG. 1 illustrates a beverage dispenser, in particular a bottled water dispenser represented by the general reference number 1. The bottled water dispenser 1 is equipped with a beverage source, in this case an industrial size water bottle 2, also known as a carboy. The carboy 2 is shown here empty for ease of reference, but has a neck 3, and a cap or membrane 4 that extends over an opening in the bottle (not shown) to form a leaktight seal over the opening of the carboy 2 and prevent escape of water or ingress of other substances into the bottle during storage and transport. The carboy 2 is placed here in a substantially vertical and inverted position, with the neck 3 and membrane or cap 4 facing down. The membrane 4 is pierced by a feeder tube 5, which is in turn connected to one or more dispensing taps 10, and a flow path means 6, 7, 11, 12, 13 and 14 providing a stream of water from the water bottle 2 to the taps 10. The connector 6 contains three inner flow passages (not shown), each inner flow passage corresponding to a different flow.

A first flow path leads from the feeder tube 5, via a three-way connector 6 to an air inlet conduit 7, that is in turn connected to an air vent 9 in which is placed an air filter unit 8, and from there to an optional air pump 65. When water is fed through the feed tube 5 into the connector 6, for example via gravity, air can enter via the air vent 9 passing through the air filter unit 8 into the air inlet conduit 7, either naturally, or via activation of the air pump 65 that will force air into the system, through the connector 6 and into the feeder tube 5, and from there can escape into the carboy 2 thereby equalizing the pressure within.

A second flow path leads from the feeder tube 5, via the connector 6 to an ambient temperature conduit 11 which is connected to the tap 10 via a second three-way connector 17, that has three inlets corresponding to number of water flows to be distributed via the tap 10. A first electrically actuated valve 15 is placed in the ambient temperature flow path and selectively closes or opens the ambient temperature conduit 11, depending on whether the operator of the dispenser wants ambient temperature water or another type of water available from one of the other flow paths.

A third flow path leads from the feeder tube 5, via the connector 6 to a beverage transport means inlet conduit 14. The inlet conduit 14 leads to an integrated cooling and carbonating core, referenced generally by the number 18. The integrated core 18 comprises a multi-chamber cooling system, the peripheral walls 19, 20 of which define respectively an outer upper chamber 21 and a inner lower chamber 22, the inner lower chamber 22 being located partially within the upper outer chamber 21 and interconnected in such a way to permit a fluid to flow from the upper chamber 21 to the lower chamber 22 and vice-versa. As illustrated by FIG. 1, the lower chamber 22 is partially located within the upper chamber 21, in an essentially concentric and axially aligned manner. Both the upper chamber 21 and lower chamber 22 are filled with a cooling transfer fluid (not shown), that is circulated within the two chambers 21, 22 by a pump 23. The cooling transfer fluid is preferably water. Since the cooling transfer fluid is essentially contained within the sealtight chambers 21, 22, it can be used for a considerable duration before having to be emptied and refreshed, for example, once a year during a routine maintenance operation. The upper 21 and lower 22 chambers can be emptied of the cooling transfer fluid via a second pump 24, located at the bottom 25 of the inner lower chamber 22.

The upper chamber 21 comprises beverage transport means distributed throughout the upper chamber 21 capable of transporting beverage to be cooled through said upper chamber 21. The beverage transport means comprise an inlet 26 and an outlet 27, interconnected via an entry conduit 28 and an exit conduit 29, and a coil 30 that is wound around the upper chamber 21. The lower chamber 22, which is axially aligned with the upper chamber 21 along a vertical axis (not shown), and located within the latter in a substantially concentric manner, has an upper zone 31 and a lower zone 32. The upper zone 31 of the lower chamber 22 is located within the upper chamber 21 and extends to the lower zone 32 of the lower chamber 22 and thereby beyond the bottom 33 of the upper chamber 21. The lower chamber 22 comprises cooling means, for example cooling means such as an evaporator coil 34, substantially located and distributed in the lower zone 32. Other cooling means can be used as appropriate, for example, a Peltier plate or a thermoelectric cooler located within a ceramic hull and insulated from the hull with a thermal exchange gel, whereby the hull can be sealingly inserted into the lower zone 32 of the lower chamber 22.

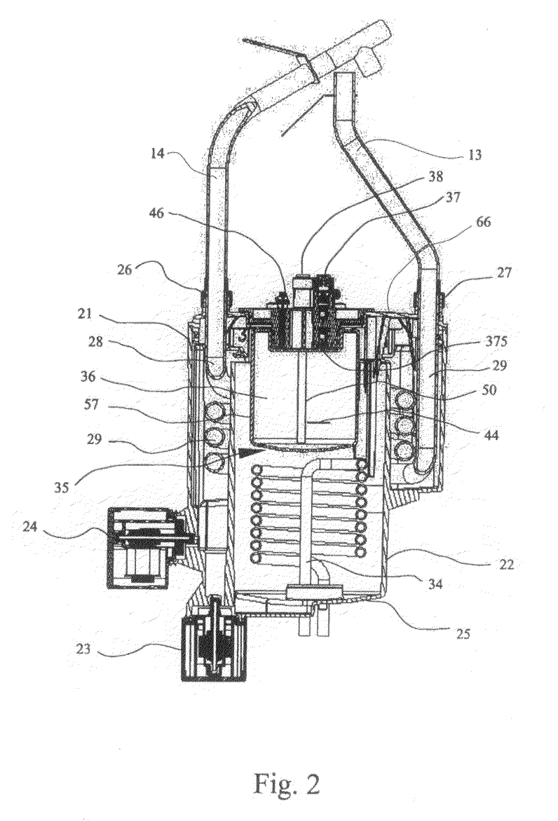

The integrated core 18 also further comprises a beverage carbonator, indicated generally on FIG. 1, and illustrated in more detail on FIG. 2. The carbonator is referenced in FIGS. 1 and 2 by the general reference number 35. The carbonator is illustrated as being located substantially in an upper zone 31 of the inner lower chamber 22, and preferably above the cooling means 34 in the lower chamber 22. When considering FIG. 2, the carbonator 35 comprises a carbonated beverage storage chamber 36, defined by a peripheral wall 57, bottom 52, and plug 51, the plug 51 enabling the carbonated beverage storage chamber 36 to be completely emptied for maintenance. The chamber 36 is capped by a carbonating head 56, which is sealingly inserted into a corresponding hollow provided in the upper peripheral wall of the storage chamber via one or more O-ring seals 53 and 54. Another O-ring seal 55 is located in the carbonator head 56 for sealtight mating of the head 56 with a cover 66 of the integrated core 18. In a most advantageous and preferred form of the invention, the peripheral wall 57 of the carbonated beverage storage chamber 36 is totally immersed in the cooling transfer fluid that is present in the upper and lower chambers 21, 22. The carbonator 35 has a volume preferably comprised between about 400 ml to about 500 ml, since this volume has been determined by the applicants as being the optimal volume for the integrated core 18. Preferably, the carbonator is made of stainless steel, since this facilitates sanitisation, as will be described later in the specification.

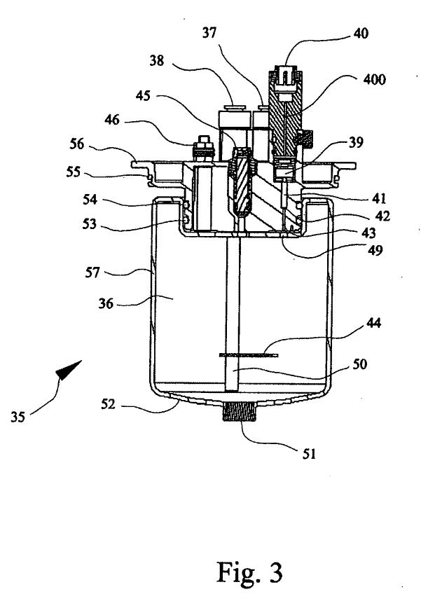

As illustrated by FIGS. 1 and 3, The carbon dioxide gas can be provided by a bottle or canister 58 of carbon dioxide gas under pressure, that is connected to the a carbon dioxide gas inlet 40 via a tap 59 and a regulator 60 and pressure gauge 61. Preferably, the pressure of the carbon dioxide gas on leaving the canister 58 and being transported along the gas inlet 40 is set to between about 4.5 bar+/−1 bar. The carbon dioxide gas enters the storage chamber 36 via inlet 40 and a primer conduit 400, which is connected to a non-return valve 39. The primer conduit 400 preferably has a reduced cross-section, for example a diameter of about 1 mm, and serves to prime a pump 62, that provides beverage to the storage chamber via the beverage inlet 37. This can be required, for example, when the pump 62 is not self-priming and the storage chamber 36 has been emptied of carbonated beverage for maintenance. In such a case, in order to prime the pump 62, the carbon dioxide enters the storage chamber via inlet 40 and primer conduit 400. Carbon dioxide gas can leave the storage chamber 36 via beverage outlet 38, the flow rate of which is controlled by electrically actuated valve 64. The flow rate of the valve 64 is set to be greater than the flow rate of incoming carbon dioxide gas, thereby causing a drop in pressure in the 1 mm diameter primer conduit 400. The drop in pressure, which is also present in the storage chamber 36, propagates to the beverage inlet 37, and to the pump, causing beverage to be drawn into the pump and prime it. The primer conduit 400 is connected to the storage chamber 36 via a non-return valve 39, and a conduit 41, comprising a stepped reduction 42 and a second narrower conduit 43 leading to a gas injection orifice 49 that opens into the storage chamber 36.

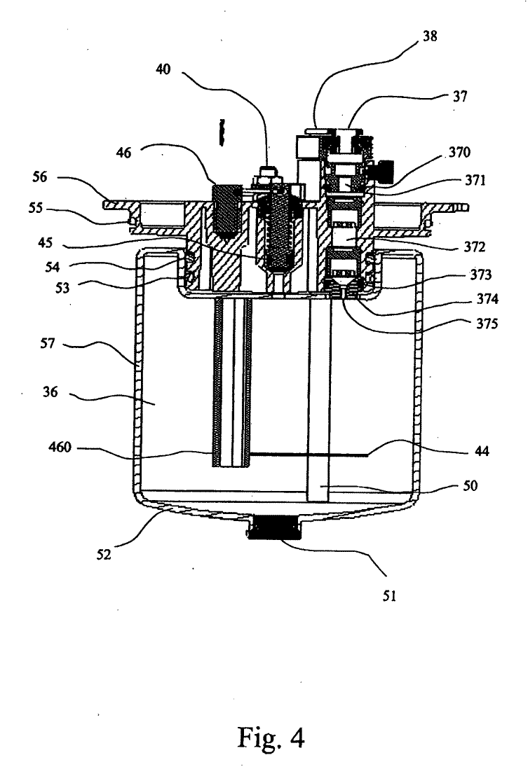

As FIG. 4 illustrates, the carbonator also comprises a beverage inlet 37 enabling beverage to enter the carbonated beverage storage chamber 36 and be stored there temporarily. The beverage inlet 37 is connected to a series of chambers 371, 372 upstream of the carbonated beverage storage chamber 36.

As can be seen in FIG. 1, the beverage inlet 37 is connected to the pump 62, that withdraws chilled beverage via a conduit 63 from the chilled water conduit 13 that extends from the beverage transport means outlet 27 to the tap 10 via connector 17. In this way, the incoming beverage stream into the carbonator 35 is cooled prior to introduction into the storage chamber 36, to a temperature comprised between about 2° C. to about 3° C. In addition, the pump 62 ensures that the beverage stream entering the storage chamber 36 is at a pressure of between about 0.5 to 7 bar, and preferably at 5 bar+/−1 bar.

As mentioned above, the carbonator 35 is substantially immersed in the cooling transfer fluid present in the chambers 21, 22. The advantage of this is that the carbon dioxide gas is pre-cooled before introduction into the storage chamber 36 to a temperature comprised between about 2° C. to about 3° C., which thereby facilitates solubilisation of the gas into the beverage stream in said mixing chamber.

As illustrated in FIG. 4, the beverage inlet 37 and storage chamber 36 are interconnected via a series of chambers 370, 372, that are connected to sprayer 374, seated in an opening in the peripheral wall 57 of the storage chamber. The sealtight seating of the sprayer 375 between the carbonator head 56 and the wall 57 is ensured by an O-ring seal 373. The sprayer contains a nozzle exit 375, that has a reduced diameter compared to the chambers 370, 372, thereby increasing the pressure of beverage at the nozzle exit 375, causing a fine dispersion of droplets or beverage particles to be formed in the storage chamber 36. This fine dispersion facilitates mixture with the carbon dioxide gas present in the storage chamber 36. The duly carbonated beverage is then stored temporarily in the mixing chamber, since beverage is only injected into the inlet 37 when an operator activates the pump 62 via the electrically actuated valve 64 that is located in a beverage outlet 38.

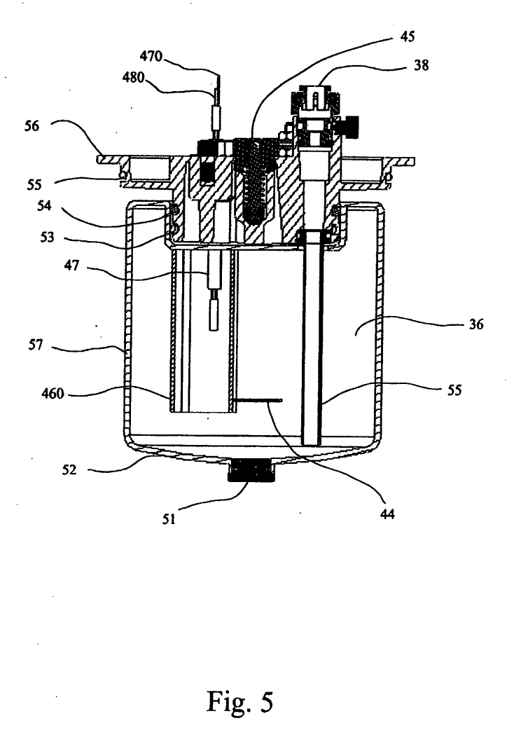

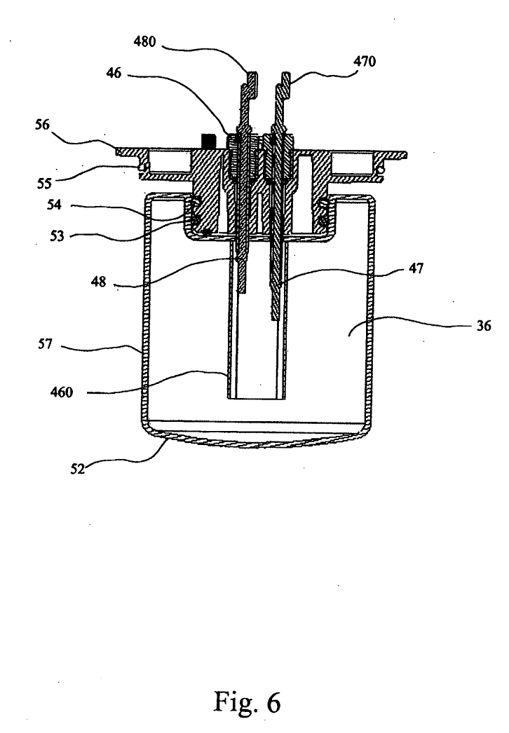

As illustrated by FIGS. 5 and 6, the carbonated beverage outlet 38 enables carbonated beverage to be withdrawn from the carbonated beverage storage chamber 36, via a carbonated beverage outlet column 50 located within the chamber. The carbonator also comprises a pressure vent 45 that communicates both with the chamber 36 and the exterior atmosphere outside of the core 18, to relieve any eventual excess gas pressure in the beverage storage chamber 36. In order to determine and maintain a sufficient level of carbonated water in the storage chamber 36, the carbonator also comprises carbonated water level detection means 46, which comprises two electrodes 47, 48 connected to an alternating current. The use of an alternating current prevents build up of deposits on, or corrosion of, the electrodes cause by electrolysis of the water and carbon dioxide gas in solution. Alternatively, a direct current can be applied to the electrodes. The electrodes 47, 48 are housed within a housing 460 that projects into the storage chamber 36, and connected electrically to the measuring circuit via electrical contacts 470 and 480. The housing 460 has a diameter and cross-section that enables the carbonated beverage level be detected within the volume formed by the housing 460, without being disturbed by eddies, boils, whirls created by the mixture of carbon dioxide gas and the spray or dispersion of beverage being ejected via the nozzle exit 375. In addition, a baffle or deflector 44, is located on and around the housing 460, and is adapted in shape and form to prevent pockets of carbon dioxide gas from forming in the beverage outlet column 50 or housing 460. In this way, it also possible to reduce the occurrence of gas pockets in the outlet stream, thereby providing a more regular distribution of the beverage from the tap 10. Regulation of carbonated beverage flow from the chamber can be controlled, for example, by axial displacement of a cone within the bore of a cylinder located within the valve 64, or even the outlet 38.

In still yet another preferred embodiment, the beverage dispenser 1 also comprises a sanitisation system connected to the integrated core 18, comprising means for generating heat of a temperature sufficient to substantially destroy any bacteria within the integrated core 18, carbonator 35 and flow path means 6, 7, 11, 12, 13, 14. The means for generating heat comprise an electric current supply connected to one or more of the flow path means 6, 7, 11, 12, 13, 14, the beverage transport means 26, 27, 28, 29, 30 and the carbonated beverage inlet 37 and outlet 38, and one or more of the former are made of an electrically conducting material, for example stainless steel. In a most preferred embodiment, the means for generating heat comprise a supply of sanitising vapour that is transported either via its own vapour pressure or via a purge system through one or more of the flow path means 6, 7, 11, 12, 13, 14, integrated core 18, and carbonator 35.

An example of the sanitisation process is described as follows. The cooling transfer fluid is emptied from chambers 21 and 22 and stored in a temporary storage chamber via pump 24. Then, any carbonated beverage remaining in the storage chamber 36 is removed via opening of the valve 64. When valve 64 is opened, the excess carbon dioxide gas pressure in the chamber 36 flushes out any remaining liquid in said chamber and along outlet 38 to the tap 10. The storage chamber 36 now only contains carbon dioxide. The carbon dioxide supply is stopped or suspended and the valve 64 actuated to cause gas to be withdrawn via outlet 38, and thereby draw any remaining beverage in the beverage transport means (27,28,29) via the pump 64 into the storage chamber 36. This also enables all of the carbon dioxide gas remaining in the system to be purged via the tap 10. An alternative solution would be to provide a connecting tube from the conduit 63 directly to the beverage inlet 37, thereby bypassing the pump 62 inlet and outlet. A transformer is electrically connected to the beverage transport means and flow paths, which are made of stainless steel, and therefore conduct electricity, and the resistance and consequential heat generated by the passage of current causes the remaining drinking water in the system to turn into steam and sterilise the whole of the dispensing system including the valves 15, 16 and 64, by operating sequentially said valves so as to direct the steam in one direction or another along the flow paths. It is to be noted that the above method of operating also enables pump 62 to be sanitised along with the rest of the system. At the end of the sanitisation operation, cooling transfer fluid that was held in a temporary storage chamber is allowed to flow back, or be pumped back via pump 24, into the chambers 21 and 22.

1. Integrated core adapted for use in a beverage dispenser system, comprising
a multi-chamber cooling system comprising an outer upper chamber and a inner lower chamber, the inner lower chamber being located partially within the upper outer chamber and interconnected in such a way to permit a fluid to flow from the upper chamber to the lower chamber and vice-versa;
beverage transport means distributed throughout the upper chamber capable of transporting beverage to be cooled through said upper chamber;
cooling means distributed throughout substantially a lower zone of the lower chamber;
cooling transfer fluid distributed throughout both chambers and capable of flowing from one chamber to the other; and
a beverage carbonator, located substantially in an upper zone of the inner lower chamber.

2. Integrated core according to claim 1, wherein the inner lower chamber is in substantial axial alignment with the upper outer chamber.

3. Integrated core according to claim 1, wherein the inner lower chamber is displaced axially with respect to the upper outer chamber.

4. Integrated core according to claim 1, wherein the cooling transfer fluid is water, a saline solution containing mineral or polymer anions or cations, or a eutectic fluid, and having a predetermined freezing point.

5. Integrated core according to claim 1, wherein the carbonator comprises:
a carbonated beverage storage chamber;
a beverage inlet enabling beverage to enter the carbonated beverage storage chamber and be stored there temporarily;
a carbonated beverage outlet enabling carbonated beverage to be withdrawn from the carbonated beverage storage chamber; and
a carbon dioxide inlet enabling carbon dioxide gas to be injected into the storage chamber.

6. Integrated core according to claim 5, wherein the incoming beverage stream is cooled prior to introduction into the storage chamber.

7. Integrated core according to claim 5, wherein the incoming beverage stream is at a pressure of between about 0.5 to 9 bar, the beverage pressure being superior to the pressure of the carbon dioxide gas entering the storage chamber.

8. Integrated core according to claim 5, wherein the carbon dioxide gas is introduced into the storage chamber at a pressure of between about 4.5 bar to 7 bar.

9. Integrated core according to claim 5, wherein the incoming beverage stream entering the storage chamber is pre-cooled at a temperature comprised between about 2° C. to about 3° C.

10. Integrated core according to claim 5, wherein the carbon dioxide gas is pre-cooled before introduction into the storage chamber to a temperature comprised between about 2° C. to about 3° C.

11. Integrated core according to claim 5, wherein the incoming beverage stream is withdrawn from the flow of beverage that has been cooled after transport via the beverage transport means through the upper chamber.

12. Integrated core according to claim 5, wherein an outflowing beverage stream leaving the storage chamber is cooled after having left the beverage outlet.

13. Integrated core according to claim 5, wherein the carbon dioxide gas inlet also comprises a conduit that extends via a stepped reduction in diameter to a second narrower conduit and an injection orifice into the beverage storage chamber.

14. Integrated core according to claim 5, wherein the carbon dioxide gas inlet also comprises a primer conduit that connects the gas inlet to a non-return valve.

15. Integrated core according to claim 1, wherein the volume of the carbonator is comprised between about 400 ml to about 1.5 litres.

16. Integrated core according to claim 5, wherein the carbonator further comprises a baffle adapted in shape and form to prevent pockets of carbon dioxide gas forming in a beverage outlet column, a vent to relieve any eventual excess gas pressure in the beverage storage chamber, and carbonated water level detection means.

17. Integrated core according to claim 16, wherein the carbonated water level detection means comprise two electrodes connected to an alternating current.

18. Integrated core according to claim 17, wherein the two electrodes are preferably housed in a housing that projects down into the carbonated beverage storage chamber.

19. Integrated core according to claim 1, wherein the carbonator is located above the cooling means in the lower chamber.

20. Integrated core according to claim 5, wherein the carbonated beverage storage chamber is totally immersed in cooling transfer fluid.

21. A beverage dispenser comprising a beverage source, one or more taps for dispensing said beverage, and a flow path means providing a stream of beverage from the source of beverage to the taps, wherein the dispenser also comprises an integrated core according to claim 1.

22. A beverage dispenser according to claim 21, wherein the dispenser also comprises a sanitization system connected to the integrated core, comprising means for generating heat of a temperature sufficient to substantially destroy any bacteria within the integrated core, carbonator and flow path means.

23. A beverage dispenser according to claim 22, wherein the means for generating heat comprise an electric current supply connected to one or more of the flow path means, the beverage transport means and the beverage inlet and carbonated beverage outlet, and one or more of the former are made of an electrically conducting material.

24. A beverage dispenser according to claim 22, wherein the means for generating heat comprise a supply of sanitizing vapor that is transported either via its own vapor pressure or via a purge system through one or more of the flow path means, integrated core, and carbonator.

25. A beverage dispenser according to claim 21, wherein the beverage is drinking water.

26. (canceled)
